(19) United States
(12) Patent Application Publication
(10) Pub. No.: US 2009/0309330 A1
(43) Pub. Date: Dec. 17, 2009

(54) Trailer apparatus

(76) Inventor: Harold James Ryan, St. Albans, VT (US)

Correspondence Address: Thomas G. Ference, 38 Thasha Lane #C6, Essex Junction, VT, 05452-4508, US

(21) Appl. No.: 12/157,868

(22) Filed: Jun. 13, 2008

(51) Int. Cl. B60D 1/48

(52) U.S. Cl. 280/462; 280/656; 280/43.13

(57) ABSTRACT

The present invention is directed to a trailer comprising a platform supported by a hitch assembly and at least one wheel assembly. The hitch assembly is for rigid attachment to a vehicle. A vertical guide mechanism connects the platform to the hitch assembly. The vertical guide mechanism includes a first vertical guide element capable of moving parallel to a second vertical guide element. The first vertical guide element is mounted to the platform and the second vertical guide element is mounted to the hitch assembly. A lifting mechanism is integrated with the vertical guide mechanism for raising and lowering the platform. When the platform is raised and lowered to the ground, the platform remains substantially parallel with the ground.

### FIELD OF THE INVENTION

This invention relates to a trailer apparatus. More specifically, it relates to a trailer apparatus that can be lowered to ground level for easy loading/unloading of cargo and then raised for travel.

### BACKGROUND OF THE INVENTION

Since the invention of the wheel, humans have been perfecting the art of transporting cargo over land. Today, motorized vehicles such as cars, trucks and recreational vehicles have become the standard means for individuals to transport themselves and their cargo. A great way to increase the versatility of these vehicles is to add a trailer behind the vehicle for carrying extra cargo. A variety of trailers exist depending on the type of vehicle towing and the type of cargo to be moved. Trailers are usually attached to the vehicle only when needed.

The most common means of attaching trailers to vehicles is to use ball or pin hitches. These types of hitches provide a pivoting joint between the trailer and the back end of the vehicle. The pivoting joint allows the wheels of the trailer and the wheels of the vehicle to work independently during turns, but still follow a similar path. Except in some very specialized applications, such as the use of pintle hitches on tandem trailers during interstate travel, United States law restricts towing to no more than one articulating hitch. More than one articulated trailer in tandem has been proven to be dangerous. Therefore certain trailers already having one pivoting joint, such as tag-alongs and fifth wheels, have no practical means for further expanding their cargo carrying capacity. A user transporting their motor home attached to their truck by a fifth wheel has no way to carry alternative transportation such as a motorcycle, moped, or all terrain vehicle (ATV) that would provide more fuel efficient transportation for the user when a destination had been reached.

Another issue with most trailers is that they do not allow for easy loading/unloading of heavy cargo. During travel the trailer must have sufficient ground clearance and therefore be at some given height above the ground. Loading of cargo to that height therefore requires either the use of a separate ramp to move the cargo from ground level to the platform or the trailer itself may be designed in a way that allows it to have one end tilt downward to touch the ground where cargo can be pushed up onto the platform. Both of these approaches still require the user to move heavy cargo up an incline.

Accordingly, there remains a continuing need for improved cargo carrying capacity on certain vehicles, especially those having tag-along trailers and fifth wheels. The current invention aims to provide a versatile way to extend the length of vehicles and allow them to carry extra equipment without the use of a second ball or pin hitch. The current invention also aims to provide for easier loading/unloading of heavy cargo.

### SUMMARY OF THE INVENTION

One aspect of the present invention is directed to a trailer comprising a platform supported by a wheel assembly and a hitch assembly, a vertical guide mechanism connecting the platform to the hitch assembly, and a lifting mechanism integrated with the vertical guide mechanism for raising and lowering the platform.

Another aspect of the present invention is directed to a trailer comprising a platform supported by a wheel assembly and a hitch assembly. A vertical guide mechanism connects the platform to the hitch assembly. The vertical guide mechanism includes a first vertical guide element capable of moving parallel to a second vertical guide element. The first vertical guide element mounted to the platform and the second vertical guide element mounted to the hitch assembly. A lifting mechanism is integrated with the vertical guide mechanism for raising and lowering the platform.

Still another aspect of the present invention is directed to a trailer comprising a platform having a back end and a front end. Wheel assemblies are mounted to the back end for supporting the platform. A hitch assembly is mounted to the front end for attaching the trailer to a vehicle. A means is provided for raising and lowering the platform to ground level. When the platform is raised and lowered to the ground, the platform remains substantially parallel with the ground.

Yet another aspect of the present invention is directed to a trailer comprising a wheel assembly including a block mount for mounting the wheel assembly. The wheel assembly further includes a block having a first side, a second side, a top and a bottom. The block is pivotably connected to the block mount by a first axle journaled in the first side of the block. A wheel is pivotably connected to the bottom of the block by a second axle journaled in the bottom of the block. When pivoting the block around the first axle, the wheel assembly can vertically collapse or extend.

### BRIEF DESCRIPTION OF DRAWINGS

The foregoing and other aspects and advantages of the invention will be apparent from the following detailed description of the invention, as illustrated in the accompanying drawings, in which:

FIG. 1 is a perspective view of the trailer apparatus of the present invention as it would be used for carrying cargo behind a vehicle;

FIG. 2 is a perspective view of the trailer apparatus;

FIG. 3a is a side elevation view showing the travel state for the trailer apparatus with the wheel assembly extended vertically and the platform raised for travel above the ground;

FIG. 3b is a side elevation view showing the loading/unloading state for the trailer apparatus with the wheels collapsed and the platform lowered to the ground;

FIG. 4 is an exploded view of the wheel assembly showing the essential elements and their relationship to one another;

FIG. 5a is a perspective view of a wheel assembly extended vertically;

FIG. 5b is a perspective view of the wheel assembly of FIG. 5a now partially extended;

FIG. 5c is a perspective view of the wheel assembly of FIG. 5b now collapsed;

FIG. 6 is a cutaway, perspective view of the vertical guide mechanism used to raise and lower the platform;

FIG. 7 is a side elevation, perspective view of a first frame incorporating a first vertical guide element;

FIG. 8 is a side elevation, perspective view of a second frame incorporating a second vertical guide element;

FIG. 9a is a sectional view through a rail of the vertical guide mechanism showing a flanged cam follower engaged between the first vertical guide element and the second vertical guide element;

FIG. 9b is a sectional view through a rail of the vertical guide mechanism showing a plain cam follower engaged between the first vertical guide element and the second vertical guide element;

FIG. 10 is a partial cutaway, perspective view of the lifting mechanism, the lifting mechanism cover being moved up to show the lifting mechanism; and

FIG. 11 is a perspective view showing the hitch assembly used for rigidly attaching the trailer apparatus to a vehicle.

### DETAILED DESCRIPTION OF THE INVENTION

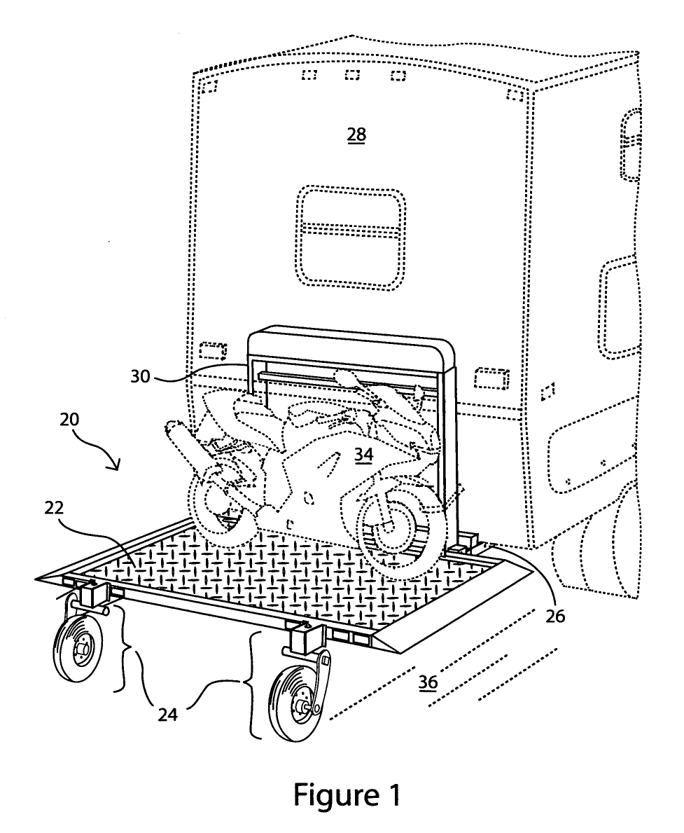

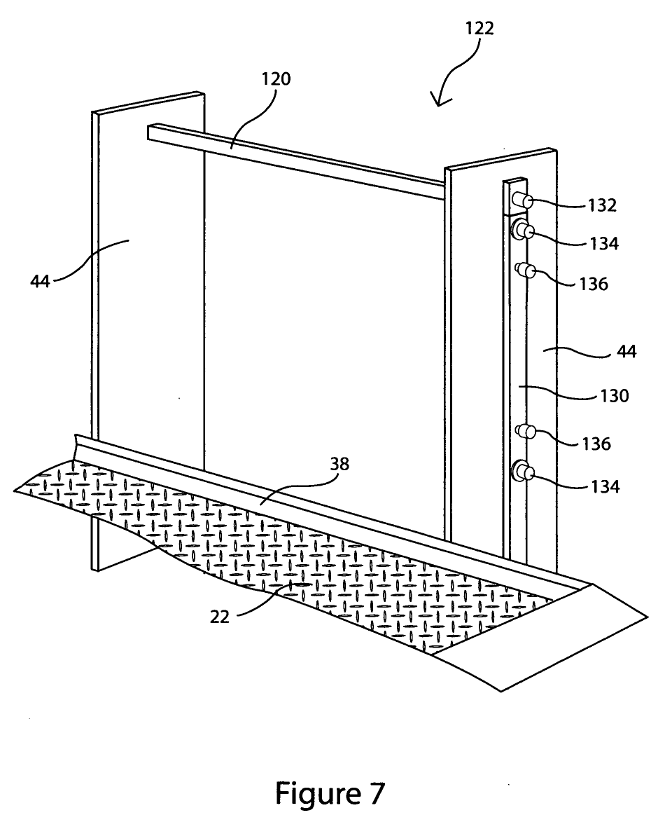

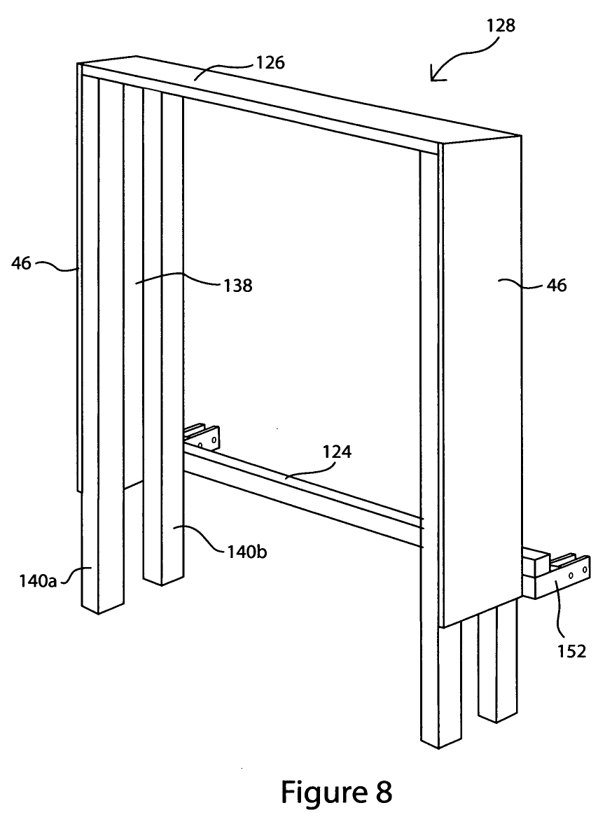

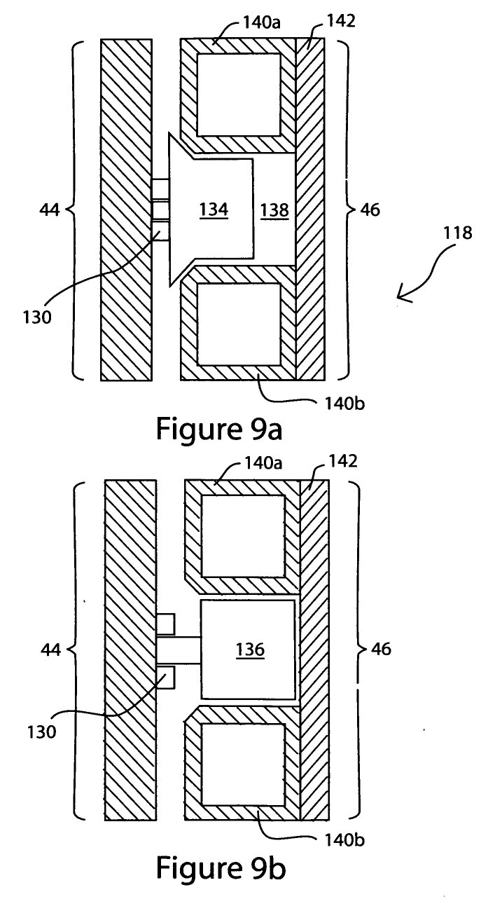

The present invention provides an improved trailer apparatus for transporting cargo behind a vehicle. FIGS. 1-11 illustrate the principles of the current invention. Trailer 20 (a.k.a. trailer apparatus) comprises a platform 22 supported by one or more wheel assemblies 24 and a hitch assembly 26. Hitch assembly 26 is for rigidly attaching the trailer to a vehicle 28. Trailer 20 further comprises a vertical guide mechanism 30 connecting platform 22 to hitch assembly 26. Vertical guide mechanism 30 allows platform 22 to move vertically relative to hitch assembly 26. A lifting mechanism 32 is integrated with vertical guide mechanism 30 for raising and lowering platform 22. Wheel assemblies 24 collapse during lowering of platform 22 to allow the platform to lie flat at ground level or roadbed level for easy loading and unloading of cargo 34. Wheel assemblies 24 extend vertically during raising of platform 22 to allow for clearance between the platform and ground 36 during travel. The current invention provides a versatile way to extend the length of vehicles and allow them to carry extra equipment without the use of an articulated hitch. The apparatus is able to transport heavy loads, such as motorcycles, golf carts, mopeds, ATVs, etc. in a stable and secure manner behind vehicle 28.

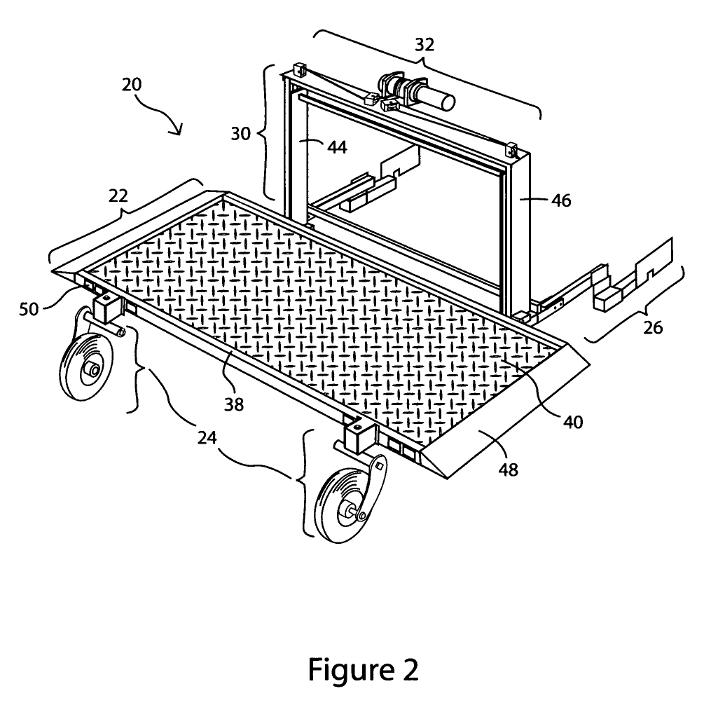

FIGS. 2-10 illustrate in more detail the components of trailer 20 and how they are integrated. Platform 22 is preferably fabricated as a frame structure 38 with a flat plate 40 secured to the frame structure. Frame structure 38 may include strengthening elements on the underside of plate 40 to provide added rigidity to platform 22. Plate 40 may have a textured surface to help prevent the cargo from sliding. Platform 22 is typically of steel construction, but may be made from other suitable rigid, high-strength materials. Platform 22 is supported by wheel assemblies 24 at the back end of the platform. The front end of platform 22 is mounted to first vertical guide element 44. Second vertical guide element 46 is mounted to and supported by hitch assembly 26. Together first vertical guide element 44 and second vertical guide element 46 make up vertical guide mechanism 30 and the vertical guide mechanism supports platform 22 by way of hitch assembly 26. Beveling 48 may be further provided to any of the edges of platform 22 to aid with easy loading and unloading of cargo when the platform is at ground level. Platform 22 may also have accessories such as lights 50 (signal, brake and backup) integrated with the platform. Lights 50 will connect electrically with vehicle 28 to meet required safety requirements. Platform 22 may further include accessories like side rails, a form fitting cover or other features to aid with securing, protecting and carrying specific types of cargo.

Trailer 20 has the unique feature of raising and lowering platform 22 to the ground. Trailer 20 does this while keeping platform 22 substantially parallel to the ground. By having platform 22 stay substantially level with the ground when raising and lowering, the level platform helps keep cargo stable. The support of wheel assemblies 24 at the back end of platform 22 is necessary since a cantilevered platform, one attached only at the front end and having no wheels, cannot easily support heavy loads without risk of failure to vertical guide mechanism 30 or hitch assembly 26. Wheel assemblies 24 reduce the amount of torque exerted on both vertical guide mechanism 30 and hitch assembly 26. Having platform 22 at ground level during the loading and unloading process makes the process easier for the user. The ability to raise and lower platform 22 to and from the ground is dependent on first a collapsible wheel assembly 24 and second having a vertical guide mechanism 30 that can raise and lower platform 22.

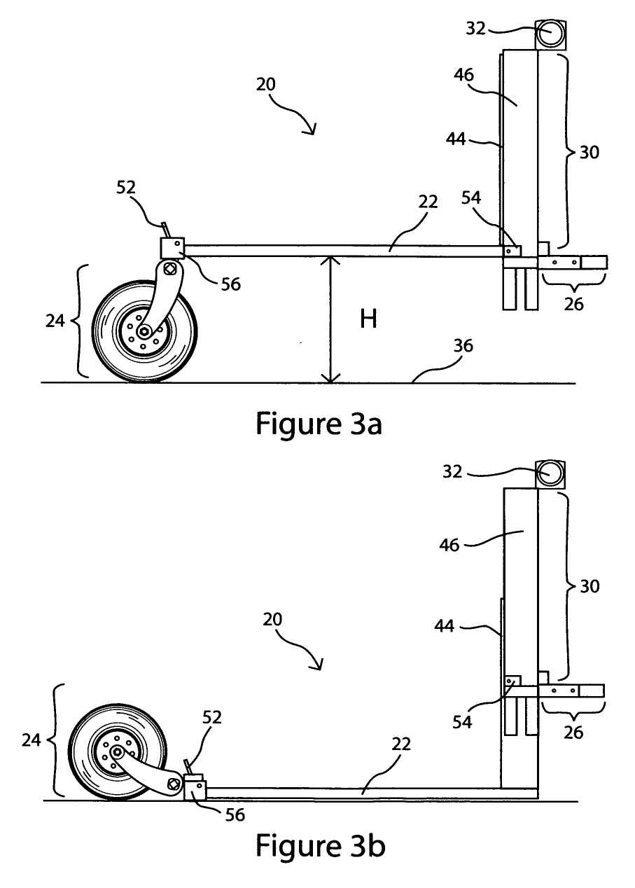

The manner in which wheel assembly 24 collapses is illustrated in FIGS. 3a and 3b. Wheel assembly 24 is shown mounted to the back end of platform 22. Two wheel assemblies 24 are preferred, one on each side, for increased stability and carrying capacity. However, one wheel assembly 24 at the center of the back end of platform 22 can support the platform. More than two wheel assemblies can also be used if the design requires it. Vertical guide mechanism 30 supports the front end of platform 22 by way of hitch assembly 26. First vertical guide element 44 is mounted to platform 22 and second vertical guide mechanism 46 is mounted to hitch assembly 26. In the travel state, platform 22 is raised a distance H above ground 36 to provide clearance for travel. Wheel assembly 24 is fully extended in the vertical direction in the travel state. A wheel collapse lock 52, a vertical guide lock 54 and first vertical guide element 44 held up by lifting mechanism 32, together all stop wheel assembly 24 from collapsing and keep platform 22 elevated. If the user wants to lower platform 22 to ground 36 for easy loading and unloading, the user first disengages wheel collapse lock 52 and vertical guide lock 54. The user then activates lifting mechanism 32 to lower first vertical guide element 44. First vertical guide element 44 moves downward parallel to second vertical guide element 46 until platform 22 reaches ground 36. The height H between platform 22 and ground 36 approaches zero as the platform is completely lowered. However, the user could stop lifting mechanism 32 at some intermediate point to have platform 22 stay at some height above ground 36. This would be a temporary state and not safe for travel. However, such an intermediate state could be used to load and unload trailer 20 from a level other than ground level, say the trailer was next to a curb. During the platform lowering process, wheel assembly 24 collapses until it is horizontal with ground 36. Once cargo has been loaded or unloaded, the process is reversed. Platform 22 is lifted by raising first vertical guide element 44. When wheel assembly 24 is fully extended in the vertical direction, wheel collapse lock 52 and vertical guide lock 54 are engaged to lock platform 22 in place.

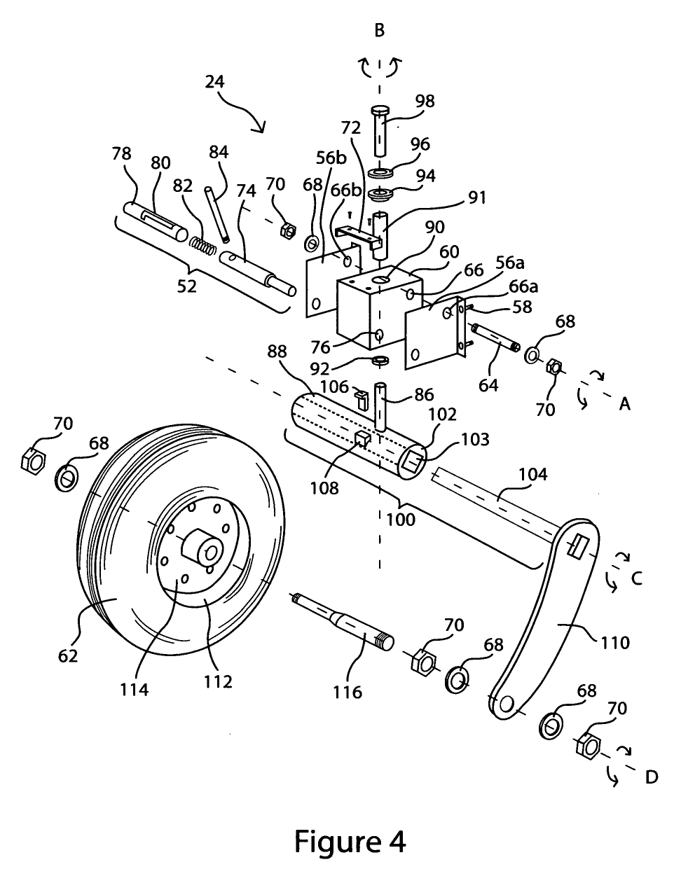

The details of the components of wheel assembly 24 are shown in FIG. 4 and how they work together are shown in FIGS. 3-5. Each wheel assembly 24 includes at least one wheel mount 56. The wheel mount 56 preferably includes a first wheel mount 56a and a second wheel mount 56b mounted to platform 24 by screws 58, welding or some other suitable mounting means. Block assembly 60 is positioned between first wheel mount 56a and second wheel mount 56b. Block assembly has a first block side, a second block side, a block bottom, a block top, a front block side and a back block side. Although block assembly 60 is referred to as a “block”, the block assembly may have a shape that differs from a block and still function as such. Block assembly 60 integrated with its associated components enables both the collapsing rotation of wheel assembly 24 and the swivel of wheel 62.

Wheel assembly 24 vertically collapses and vertically extends by rotating the assembly around axis A. First axle 64 is journaled from the first block side to the second block side through first hole 66. First axle 64 also extends through holes 66a and 66b, respectively, in first wheel mount 56a and second wheel mount 56b. Washers 68 and lock nuts 70 are used on both ends of axle 64 to hold it in place. A block stop 72 mounted to block assembly 60 may be provided to the stop block assembly from rotating beyond a point where wheel 62 could collapse under platform 22. Block stop 72 also helps to align block lock pin 74 of wheel collapse lock 52 to second hole 76. Wheel collapse lock 52 further includes a collapse lock housing 78 having an L-shaped slot 80. A spring 82 is placed within collapse lock housing 78 and block lock pin 74 can be moved in and out of second hole 76 along L-shaped slot 80 by handle 84 to lock the block assembly 60 in place when traveling. Spring 82 provides a bias to keep block lock pin 74 in second hole 76.

Wheel 62 of wheel assembly 24 swivels around axis B. A second axle 86, the swivel axle, extending at right angles to torque flex axle housing 88 is journaled from the bottom to the top of block assembly 60 through third hole 90. An oil light bearing sleeve 91 surrounds axle 86, within third hole 90. Bearing assembly 92, block spacer 94, thrush washer 96 and bolt 98 are all further integrated with axle 86 to allow it to pivot while bearing the weight of platform 24 and any cargo. The swivel capability provides for wheel 62 to be able to move in all directions along the ground surface.

The damping of vibrations in wheel assembly 24 during travel is provided by torque flex assembly 100 that lies along and pivots with a bias around axis C. Torque flex axle 100 includes elongated torque flex axle housing 88 filled with resilient material 102 that surrounds shaft 104. Resilient material 102 is preferably rubber. During fabrication resilient material 102 has a shaft hole 103, preferably of square cross-section, formed along its center axis. Shaft 104, also preferably of square cross-section, is placed within shaft hole 103. Resilient material 102 is then compressed and frozen. In the frozen state, resilient material 102 containing shaft 104 is then placed within torque flex axle housing 88 and allowed to warm. Upon warming, resilient material 102 expands to fill torque flex axle housing 88. Resilient material 102 provides for a bias that increases with the amount of pivot from a neutral position around axis C. The bias acts to damp the vibrations from wheel 62 by way of swing arm 110 that is mounted at a right angle to torque flex axle assembly 100. Torque flex axle assembly 100 is mounted at right angles to second axle 86. A swivel lock pin 106 and a swivel lock pin housing 108 combine to form a swivel lock. The swivel lock is for stoping wheel 62 from swiveling when raising and lowering wheel assembly 24.

Wheel 62 of wheel assembly 24 spins around axis D. Wheel 62 is mounted on a rim 112 with a hub assembly 114. Hub assembly 114 includes the bearing and race along with an oil seal. A spindle 116 is journaled though the center of hub assembly 114. Washers 68 and lock nuts 70 are used to secure spindle 116 to wheel 62 and swing arm 110.

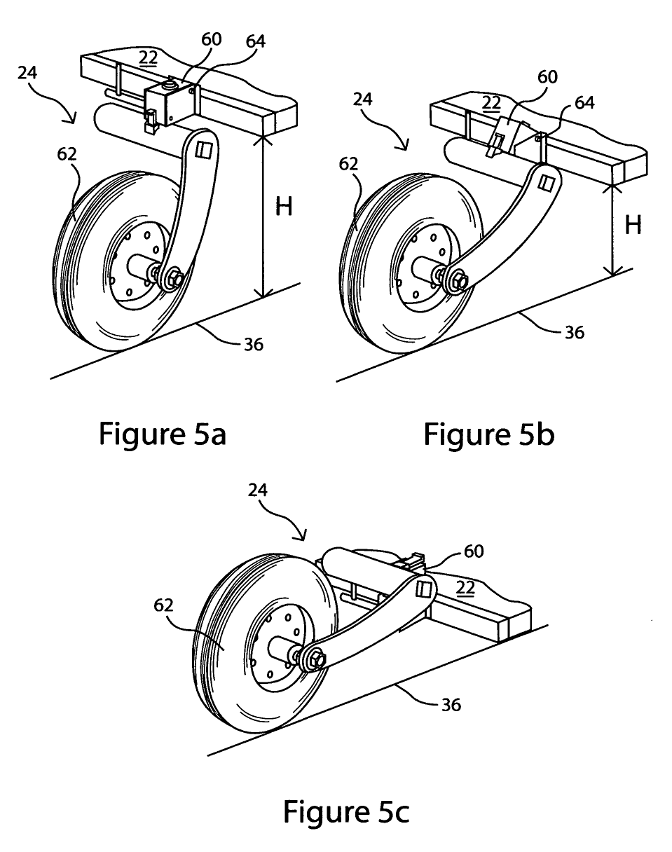

FIG. 5a further shows the manner in which the components described above work together to vertically collapse wheel assembly 24. In FIG. 5a wheel assembly 24 is fully extended in the vertical direction. In this position platform 22 is at a height H above ground 36. In FIG. 5b, the wheel assembly 24 is shown partially collapsed. Here block assembly 60 is partially rotated around first axle 64. As platform 22 is lowered all the way to the ground, FIG. 5c, block assembly 60 has now rotated a full ninety degrees around first axle 64.

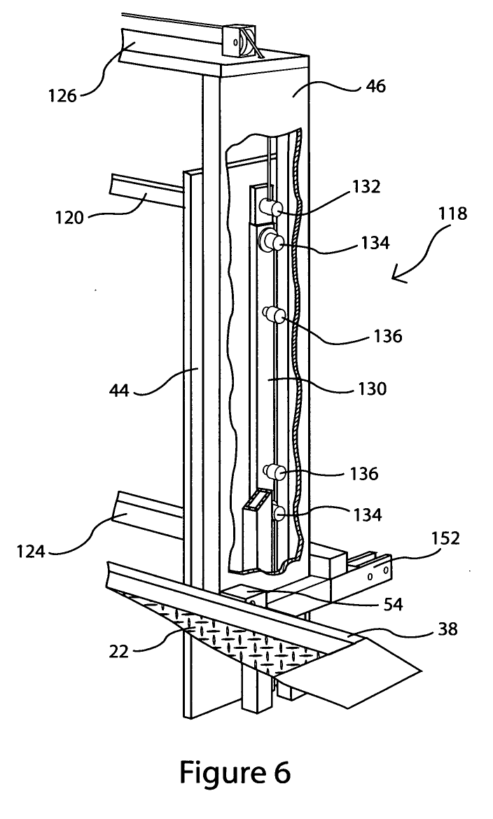

FIGS. 6-9 illustrate vertical guide mechanism 30. Vertical guide mechanism 30 includes a first vertical guide element 44 and a second vertical guide element 46. Together first vertical guide element 44 and second vertical guide element 46 combine to form a sliding rail assembly 118. It is preferable to have two rail assemblies 118 positioned along the front end of platform 22, one near each side of the platform. The lower portion of each first vertical guide element 44 is mounted to platform 22 by way of frame structure 38. The upper portion of each first vertical guide element 44 is supported by first cross bar 120. Together each of the first vertical guide elements 44, frame structure 38 and first crossbar 120 create a first guide frame 122. The lower portion of each second vertical guide element 46 is mounted to hitch assembly 26 by way of second crossbar 124. The upper portion of each second vertical guide element 46 is supported by top cross bar 126. Together each of the second vertical guide elements 46, second crossbar 124 and top crossbar 126 create a second guide frame 128. The outer sides of first guide frame 122 (being first vertical guide element 44) slides within the inner sides of second guide frame 128 (being second vertical guide element 46). First vertical guide element 44 is mounted to platform 22 in such a manner so that the platform is oriented substantially parallel to the ground. Second vertical guide element 46 is mounted to hitch assembly 26. In this manner platform 22 can move substantially parallel to the ground as first vertical guide element 44 and second vertical guide element 46 move parallel to each other. It is preferable to have first vertical guide element 44 mounted at a right angle to platform 22, however, vertical guide mechanism 30 could be designed to be at an angle other than vertical and still raise and lower platform 22 substantially parallel to the ground.

The ability for first vertical guide element 44 to move parallel to second vertical guide element 46 is defined by the structure of these elements and how they integrate together. First vertical guide element 44 has a bar 130 that runs along the length of its outer side. At the top end of bar 130 is a lifting mechanism support pin 132. Below support pin 132 are guide components, in this particular embodiment two pairs of cam followers 134 and 136, one set mounted to and near each end of bar 130. Flanged cam follower 134 and plain cam follower 136 both have bearings that allow them to rotate freely when they contact a moving surface. Second vertical guide element is constructed to have a channel 138 along the inner side. Channel 138 is preferably formed by welding two steel tubes 140a and 140b to a flat plate 142. Channel 138 could also be a channel milled in a plate, however, the tube construction provides for a lighter weight part. Cam followers 134 and 136 spin freely within channel 138 when moving first vertical guide element 44 parallel to second vertical guide element 46. Plain cam follower 136 follows the tight tolerance of channel 138 between steel tubes 140a and 140b and provides side-to-side stability between steel tubes 140a and 140b. Flanged cam follower 134 helps stabilize both the side-to-side motion of first vertical guide element 44 relative to second vertical guide element 46 as well as stabilize the spacing between the first vertical guide element and the second vertical guide element as the elements move past each other.

Alternative embodiments may be employed for vertical guide mechanism 30 without deviating from the scope of this invention. For example, instead of cam followers, guide mechanism 30 may be designed to use plastic components that line the surfaces where both first vertical guide element 44 and second vertical guide element 46 come in contact so that they glide easily past each other. Alternatively, instead of having a channel 138, first vertical guide element 44 could be a bar and second vertical guide element 46 another bar that has cam followers or other glide components attached to it that roll or glide along the outer surface of the first vertical guide element.

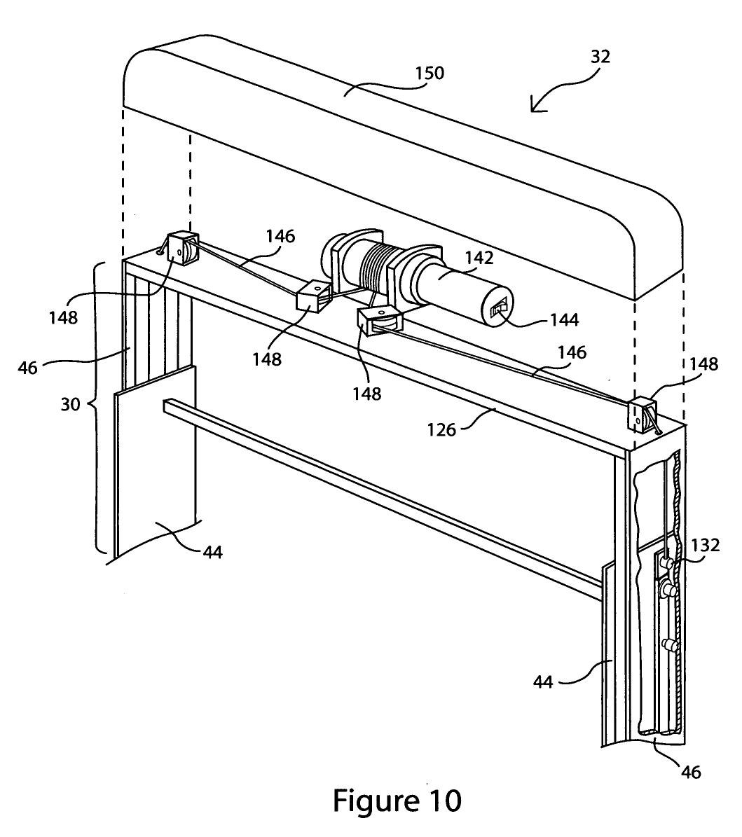

FIG. 10 illustrates the details of lifting mechanism 32. Lifting mechanism 32 is integrated with vertical guide mechanism 30 to provide the necessary means for moving first vertical guide element 44 parallel to second vertical guide element 46. Lifting mechanism 32 includes a motor 142 mounted to top bar 126 of second guide frame 128. Motor 142 has an on/off switch 144 with raising and lowering capabilities. Motor 142 may also be a remotely controlled motor to provide a remotely controlled lifting mechanism. Power to drive motor 142 may be obtained from vehicle 28 or the motor may have its own separate power source. A cable 146 integrated through a system of pulleys 148 connects motor 142 to each first vertical guide element 44. Connection of cable 146 is made by way of support pin 132. When motor 142 is activated to raise, a portion of the motor rotates in one direction to shorten cable 146, this in turn lifts first vertical guide element 44 relative to second vertical guide element 46. When motor 142 is activated to lower, a portion of the motor rotates in the opposite direction to lengthen cable 146, this in turn lowers first vertical guide element 44 relative to second vertical guide element. When a pair of first vertical guide elements 44 and second vertical guide elements 46 exist, as with first vertical guide frame 122 and second vertical guide frame 128, a pair of cables 146 can be used to in cooperation with sets of pulleys 148 to raise and lower platform 22. A lifting mechanism cover 150 is provided to keep it dust and rain free.

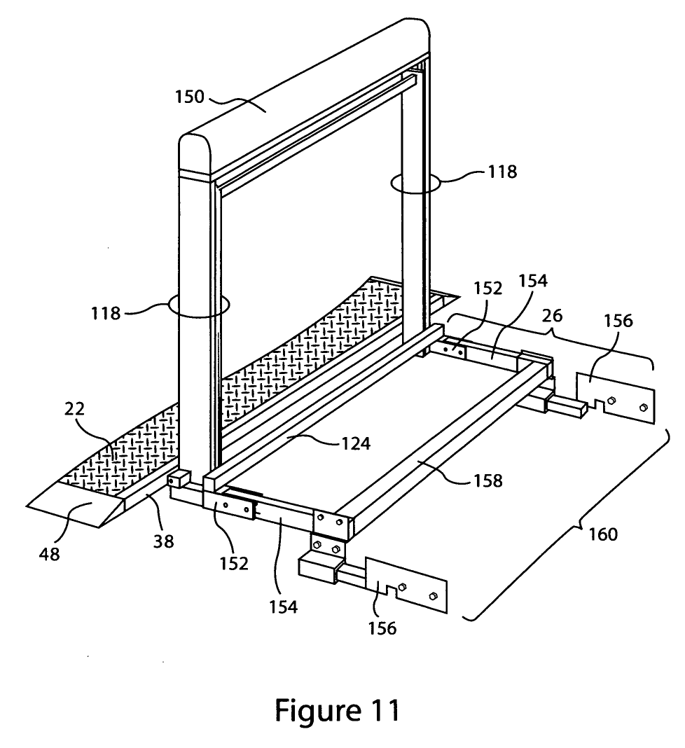

FIG. 11 illustrates the details of hitch assembly 26. Hitch 26 includes dual receivers 152 mounted to the base of second vertical guide element 46. Each receiver 152 mates with a receiver post 154. Together the receiver posts 154 and hitch bar 158 make up receiver hitch 160. Receiver hitch 160 also has mounting plates 156. Mounting plates 156 mount to vehicle 28. Together the receivers 152 and receiver hitch 158 provide a rigid way to mount trailer 10 proximate the back of vehicle 28. Although a preferred structure for the hitch assembly is presented in FIG. 11, many other means of rigidly mounting vertical guide mechanism 30 exist without deviating from the scope of this invention.

Trailer apparatus 20 is designed to function with transport vehicles such as fifth wheels, tag-along trailers or other similar devices. The current invention provides a versatile way to extend the length of these vehicles. It allows for carrying extra equipment outside the vehicle without the use of an articulated hitch that might otherwise be prohibited. The apparatus is able to transport heavy loads such as motorcycles, golf carts, mopeds, ATVs, etc. in a stable and secure manner behind the vehicle. Another key feature of the apparatus is the ability to load heavy cargo onto trailer 20 without the use of ramps, this is done by having the carrying surface of platform 22 near ground level during loading and unloading.

The invention is not limited to the embodiments represented and described above but includes all variants notably the shape and size of all components, the number of wheel assemblies used to support the platform, the exact structure of the vertical guide mechanism and the materials that the trailer components are manufactured from. Nothing in the above specification is intended to limit the invention more narrowly than the appended claims. The examples given are intended only to be illustrative rather than exclusive.

1) A trailer comprising;
a) a platform supported by a wheel assembly and a hitch assembly;
b) a vertical guide mechanism connecting said platform to said hitch assembly; and
c) a lifting mechanism integrated with said vertical guide mechanism for raising and lowering said platform.

2) A trailer as recited in claim 1, wherein said platform remains substantially parallel to the ground when said platform is raised and lowered.

3) A trailer as recited in claim 1, wherein said wheel assembly collapses during lowering of said platform to allow said platform to lie at ground level for easy loading of cargo.

4) A trailer as recited in claim 1, wherein said wheel assembly extends vertically during raising to allow for clearance between said platform and the ground during travel.

5) A trailer as recited in claim 1, wherein said wheel assembly can be locked to a given height.

6) A trailer as recited in claim 1, wherein said wheel assembly includes a wheel mount mounted to said platform and a block assembly having a first side and bottom; wherein said block assembly is pivotably connected to said wheel mount by a first axle journaled in said first side of said block assembly; and wherein a wheel is pivotably attached to said bottom of said block assembly by a second axle journaled in said bottom of said block assembly.

7) A trailer as recited in claim 1, wherein said wheel assembly includes a wheel that swivels to allow for movement of said trailer in all directions.

8) A trailer as recited in claim 1, wherein said wheel assembly includes a torque flex axle assembly for damping vibrations during travel.

9) A trailer as recited in claim 1, wherein said wheel assembly includes a first wheel assembly and a second wheel assembly each mounted to said platform opposite said hitch assembly.

10) A trailer as recited in claim 1, wherein said vertical guide mechanism includes a first vertical guide element capable of moving parallel to a second vertical guide element.

11) A trailer as recited in claim 10, wherein said first vertical guide element is mounted to said platform so that said platform is oriented substantially parallel to the ground.

12) A trailer as recited in claim 10, wherein said second vertical guide element is mounted to said hitch assembly.

13) A trailer as recited in claim 10, wherein said vertical guide mechanism further includes a guide component mounted to said first vertical guide element and a channel formed within said second vertical guide.

14) A trailer as recited in claim 13, wherein when said first vertical guide element moves parallel to said second vertical guide element said guide component travels along said channel.

15) A trailer as recited in claim 13, wherein guide component is at least one from the group including a flanged cam follower and a plain cam follower.

16) A trailer as recited in claim 1, wherein said vertical guide mechanism includes a first frame having a first vertical guide element and a second frame having a second vertical guide element.

17) A trailer as recited in claim 1, wherein said hitch assembly is for rigidly mounting said trailer to a vehicle.

18) A trailer as recited in claim 1, further comprising accessories attached to said platform, said accessories at least one from the group including signal lights, brake lights, backup lights, side rails and a form-fitting cover.

19) A trailer as recited in claim 10, wherein said lifting mechanism is for moving said first vertical guide element parallel to said second vertical guide element.

20) A trailer as recited in claim 1, wherein said lifting mechanism includes at least one from the group including a motor, a switch, a pulley and a cable.

21) A trailer as recited in claim 1, wherein said lifting mechanism is a remotely controlled lifting mechanism.

22) A trailer comprising:
a) a platform having a back end and front end;
b) at least one wheel assembly mounted to said back end for supporting said platform;
c) a hitch assembly integrated with said front end for attaching said trailer to a vehicle;
d) means for raising and lowering said platform to ground level; and
e) wherein said platform remains substantially parallel with the ground when said platform is raised and lowered.

23) A trailer as recited in claim 22, further comprising means for rigidly attaching said hitch assembly to a vehicle.

24) A trailer comprising:
a) a platform having a carrying surface, wherein said platform is supported by a wheel assembly and a hitch assembly; and
b) means for raising and lowering said carrying surface parallel to ground level.

25) A wheel assembly comprising:
a) a wheel mount for mounting said wheel assembly;
b) a block assembly having a first side, a second side, a top and a bottom, wherein said block assembly is pivotably connected to said wheel mount by a first axle journaled in said first side of said assembly block;
c) a wheel pivotably connected to said bottom of said block assembly by a second axle journaled in said bottom of said block assembly; and
d) wherein when said block assembly pivots around said first axle, said wheel assembly does at least one from the group including collapses and vertically extends.

26) A wheel assembly as recited in claim 25, wherein said wheel swivels around said second axle.

27) A wheel assembly as recited in claim 25, wherein said first axle is journaled from said first side to said second side of said block assembly.

28) A wheel assembly as recited in claim 25, wherein said second axle is journaled from said bottom to said top of said block assembly.

29) A wheel assembly as recited in claim 25, wherein said first axle is at a right angle to said second axle.

30) A wheel assembly as recited in claim 25, wherein said wheel mount includes a first wheel mount and a second wheel mount, said first wheel mount pivotably connected to said first side and said second wheel mount pivotably connected to said second side.

31) A wheel assembly as recited in claim 25, further comprising a torque flex axle assembly mounted at a right angle to said second axle.

32) A wheel assembly as recited in claim 31, wherein said torque flex aide assembly includes an elongated housing filled with a resilient material surrounding a shaft.

33) A wheel assembly as recited in claim 31, further comprising a swing arm mounted at a right angle to said torque flex axle assembly.

34) A wheel assembly as recited in claim 33, further comprising a wheel pivotably connected at a right angle to said swing arm.

35) A wheel assembly as recited in claim 25, further comprising a swivel lock.

36) A wheel assembly as recited in claim 25, further comprising a wheel collapse lock.
